(19) United States
(12) Patent Application Publication
(10) Pub. No.: US 2017/0283048 A1
(43) Pub. Date: Oct. 5, 2017

(54) CONVERTABLE LIFTING PROPELLER FOR UNMANNED AERIAL VEHICLE

(71) Applicant: Amazon Technologies, Inc., Seattle, WA (US)

(72) Inventors: Brian C. Beckman, Newcastle, WA (US); Noam Sorek, Zichron Yaccov (IL)

(21) Appl. No.: 15/083,758

(22) Filed: Mar. 29, 2016

(51) Int. Cl. B64C 27/24; B64C 39/02

(52) U.S. Cl. CPC B64C 27/24; B64C 39/024; B64C 2201/108

(57) ABSTRACT

Described is a configuration of an unmanned aerial vehicle (“UAV”) that includes one or more lifting propellers that may be converted between an operational configuration and a transit configuration. When the lifting propeller is in a operational configuration, the leading edge of each propeller blade is aligned in the direction of rotation so that the lifting propeller will generate a positive lifting force when rotated by a lifting motor. When the lifting propeller is in the transit configuration, the leading edge of each of the propeller blades are oriented toward a direction of a transit flight of the aerial vehicle. Likewise, the lifting propeller is maintained in a fixed position during the transit flight so that airflow passing over the propeller blades of the lifting propeller cause vertical lift.

### BACKGROUND

The use of unmanned aerial vehicles (“UAV”) having two or more propellers is increasingly common. Such vehicles include quad-copters (e.g., a UAV having four rotatable propellers), octo-copters (e.g., a UAV having eight rotatable propellers), or other vertical take-off and landing (“VTOL”) aircraft having two or more propellers.

The availability of excess lift is most essential during take-off and landing evolutions of a UAV. Precision control of altitude is critical when a UAV attempts to take off from or land at a given location, in order to enable the UAV to avoid any surrounding objects, structures, animals (e.g., humans), or other UAVs that may be located nearby when taking off or landing. Accordingly, multi-rotor UAVs are commonly equipped with greater lift capacity than is commonly utilized during most transiting operations, such that excess lift is available when needed, primarily in take-offs or landings.

In order to conserve onboard electrical power when excess lift is not desired, rotation of one or more propellers of a UAV may be shut down when the UAV is transiting, or in a thrust mode, such as after the UAV has successfully taken off, and recommenced when the UAV prepares to land at a given location. For example, a UAV may feature sets of thrusting propellers and lifting propellers. When a maximum amount of lift is desired, both the thrusting propellers and the lifting propellers may be operated. When the maximum amount of lift is no longer desired, however, the operation of the lifting propellers may be stopped, thereby reducing the amount of electrical power consumed during operations. A propeller that is provided on an operating UAV and is at rest may create undesirable drag and restrict the stability of the UAV during transit operations.

### BRIEF DESCRIPTION OF THE DRAWINGS

The detailed description is set forth with reference to the accompanying figures. In the figures, the left-most digit(s) of a reference number identifies the figure in which the reference number appears.

FIG. 1 depicts a view of an unmanned aerial vehicle configuration, according to an implementation.

FIG. 2A depicts a view of a lifting propeller in an operational configuration, according to an implementation.

FIG. 2B depicts a view of the lifting propeller from FIG. 2A in a transit configuration, according to an implementation.

FIGS. 3A-3C illustrate views of a propeller blade of a lifting propeller, according to an implementation.

FIG. 4A depicts a view of a lifting propeller in an operational configuration, according to an implementation.

FIG. 4B depicts a view of the lifting propeller from FIG. 4A in a transit configuration, according to an implementation.

FIG. 5A depicts a view of a lifting propeller in an operational configuration, according to an implementation.

FIG. 5B depicts a view of the lifting propeller from FIG. 5A in a transit configuration, according to an implementation.

FIG. 6A depicts a view of a lifting propeller in an operational configuration, according to an implementation.

FIG. 6B depicts a view of the lifting propeller from FIG. 6A in a transit configuration, according to an implementation.

FIG. 7 depicts a top-down view of a UAV with different lifting propeller configurations, according to an implementation.

FIG. 8 is a block diagram of an illustrative implementation of an aerial vehicle control system that may be used with various implementations.

While implementations are described herein by way of example, those skilled in the art will recognize that the implementations are not limited to the examples or drawings described. It should be understood that the drawings and detailed description thereto are not intended to limit implementations to the particular form disclosed but, on the contrary, the intention is to cover all modifications, equivalents and alternatives falling within the spirit and scope as defined by the appended claims. The headings used herein are for organizational purposes only and are not meant to be used to limit the scope of the description or the claims. As used throughout this application, the word “may” is used in a permissive sense (i.e., meaning having the potential to), rather than the mandatory sense (i.e., meaning must). Similarly, the words “include,” “including,” and “includes” mean “including, but not limited to.” Additionally, as used herein, the term “coupled” may refer to two or more components connected together, whether that connection is permanent (e.g., welded) or temporary (e.g., bolted), direct or indirect (i.e., through an intermediary), mechanical, chemical, optical, or electrical. Furthermore, as used herein, “horizontal” or “transit” flight refers to flight traveling in a direction substantially parallel to the ground (i.e., sea level), and that “vertical” flight refers to flight traveling substantially radially outward from the earth's center. It should be understood by those having ordinary skill that trajectories may include components of both “horizontal” or “transit” and “vertical” flight vectors.

### DETAILED DESCRIPTION

This disclosure describes a configuration of an unmanned aerial vehicle (“UAV”) that includes one or more lifting propellers that may be converted between an operational configuration and a transit configuration. When the lifting propeller is in an operational configuration, the leading edge of each propeller blade is aligned in the direction of rotation so that the lifting propeller will generate a positive lifting force when rotated by a lifting motor. When the lifting propeller is in the transit configuration, the leading edge of each of the propeller blades are oriented toward a direction of a transit flight of the aerial vehicle. Likewise, the lifting propeller is maintained in a fixed position during the transit flight so that airflow passing over the propeller blades of the lifting propeller causes vertical lift.

The UAV may have any number of lifting motors and corresponding lifting propellers. For example, the UAV may include four lifting motors and lifting propellers (also known as a quad-copter), eight lifting motors and lifting propellers (also known as an octo-copter), etc., each of which may be mounted to the central frame at corresponding motor mounts. Likewise, to improve the efficiency of horizontal flight, the UAV may also include one or more thrusting motors and thrusting propellers that are oriented at approximately ninety degrees to one or more of the lifting motors and/or the frame of the UAV. When the UAV is moving in a direction that includes a horizontal component, also referred to herein as transit flight, the thrusting motor(s) may be engaged and the thrusting propeller(s) will aid in the horizontal propulsion of the UAV. In some implementations, the rotation of the lifting motors may be terminated when the thrusting motor(s) is engaged, thereby improving efficiency and reducing power consumption of the UAV.

Rather than aligning the lifting propellers parallel with the direction of the transit flight, the configuration of the lifting propeller may be altered and the lifting propeller aligned so that it generates a lift from airflow passing over the propeller blades during the transit flight. For example, if the lifting propeller includes two propeller blades, the propeller may be aligned so that the two propeller blades are aligned substantially perpendicular to the direction of the transit flight. Likewise, one of the two propeller blades may rotate approximately 180 degrees so that the leading edge of both propeller blades are oriented in the direction of the transit flight. Alternatively, the propeller blades may be hinged at the hub such that one of the propeller blades may be rotated approximately 180 degrees about the hinge so that the leading edge of both propeller blades are oriented in the direction of the transit flight.

The airfoil shape and alignment of the propeller blades cause an upward lift as the airflow passes over the propeller blades. In some implementations, the airfoil shape may be altered to increase or decrease a lift and/or drag of the propeller blade. For example, one or more of the camber, blade thickness, chord, pitch, an angle of attack distribution, camber distribution, rake angle, and/or axial offset of the blade into different planes may be altered. Likewise, such alteration may be performed across the entire blade or at one or more radial stations along the propeller blade. For example, if the propeller blade is segmented into thirty radial stations, the airfoil shape at one or more of those radial stations may be altered.

In implementations with more than two propeller blades, one or more of the propeller blades may be aligned such that it is approximately parallel with the direction of the transit flight and the other propeller blades are aligned so that they are not parallel with the direction of the transit flight. Likewise, the orientation of one or more of the propeller blades that are not aligned parallel with the direction of the transit flight may be rotated so that the leading edge of each propeller is oriented in the direction of the transit flight.

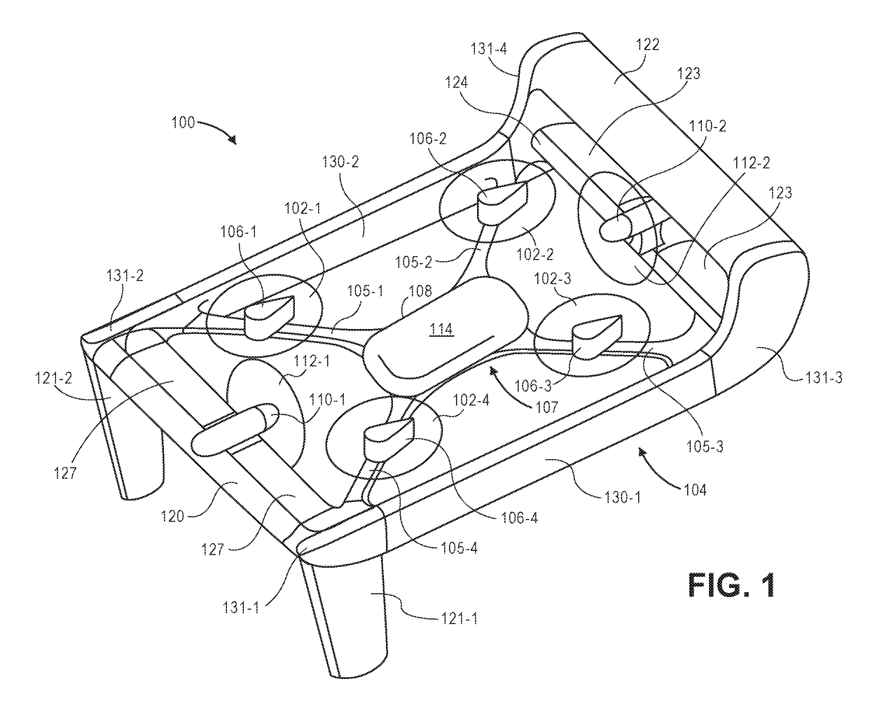

FIG. 1 illustrates a view of a UAV 100, according to an implementation. As illustrated, the UAV 100 includes a perimeter frame 104 that includes a front wing 120, a lower rear wing 124, an upper rear wing 122, and two horizontal side rails 130-1, 130-2. The horizontal side rails 130 are coupled to opposing ends of the front wing 120 and opposing ends of the upper rear wing 122 and lower rear wing 124. In some implementations, the coupling may be with a corner junction, such as the front left corner junction 131-1, the front right corner junction 131-2, the rear left corner junction 131-3, the rear right corner junction 131-4. In such an example, the corner junctions are also part of the perimeter frame 104.

The components of the perimeter frame 104, such as the front wing 120, lower rear wing 124, upper rear wing 122, side rails 130-1, 130-2, and corner junctions 131 may be formed of any one or more suitable materials, such as graphite, carbon fiber, aluminum, titanium, etc., or any combination thereof. In the illustrated example, the components of the perimeter frame 104 of the UAV 100 are each formed of carbon fiber and joined at the corners using corner junctions 131. The components of the perimeter frame 104 may be coupled using a variety of techniques. For example, if the components of the perimeter frame 104 are carbon fiber, they may be fitted together and joined using secondary bonding, a technique known to those of skill in the art. In other implementations, the components of the perimeter frame 104 may be affixed with one or more attachment mechanisms, such as screws, rivets, latches, quarter-turn fasteners, etc., or otherwise secured together in a permanent or removable manner.

The front wing 120, lower rear wing 124, and upper rear wing 122 are positioned in a tri-wing configuration and each wing provides lift to the UAV 100 when the UAV is moving in a direction that includes a horizontal component, also referred to herein as transit flight. For example, the wings may each have an airfoil shape that causes lift due to the airflow passing over the wings during transit flight.

Opposing ends of the front wing 120 may be coupled to a corner junction 131, such as the front left corner junction 131-1 and front right corner junction 131-2. In some implementations, the front wing may include one or more flaps 127 or ailerons, that may be used to adjust the pitch, yaw, and/or roll of the UAV 100 alone or in combination with the lifting motors 106, lifting propellers 102, thrusting motors 110, thrusting propellers 112, and/or other flaps on the rear wings, discussed below. In some implementations, the flaps 127 may also be used as a protective shroud to further hinder access to the lifting propellers 102 by objects external to the UAV 100. For example, when the UAV 100 is moving in a vertical direction or hovering, the flaps 127 may be extended to increase the height of the protective barrier around a portion of the lifting propellers 102.

In some implementations, the front wing 120 may include two or more pairs of flaps 127, as illustrated in FIG. 1. In other implementations, for example if there is no front thrusting motor 110-1, the front wing 120 may only include a single flap 127 that extends substantially the length of the front wing 120. If the front wing 120 does not include flaps 127, the lifting motors 106 and lifting propellers 102, thrusting motors 110, thrusting propellers 112 and/or flaps of the rear wings may be utilized to control the pitch, yaw, and/or roll of the UAV 100 during flight.

Opposing ends of the lower rear wing 124 may be coupled to a corner junction 131, such as the rear left corner junction 131-3 and rear right corner junction 131-4. In some implementations, the lower rear wing may include one or more flaps 123 or ailerons, that may be used to adjust the pitch, yaw and/or roll of the UAV 100 alone or in combination with the lifting motors 106, lifting propellers 102, thrusting motors 110, thrusting propellers 112, and/or the flaps 127 of the front wing. In some implementations, the flaps 123 may also be used as a protective shroud to further hinder access to the lifting propellers 102 by objects external to the UAV 100. For example, when the UAV 100 is moving in a vertical direction or hovering, the flaps 123 may be extended, similar to the extending of the front flaps 127 of the front wing 120.

In some implementations, the rear wing 124 may include two or more flaps 123, as illustrated in FIG. 1 or two or more pairs of flaps. In other implementations, for example if there is no rear thrusting motor 110-2 mounted to the lower rear wing, the rear wing 124 may only include a single flap 123 that extends substantially the length of the lower rear wing 124. In other implementations, if the lower rear wing includes two thrusting motors, the lower rear wing may be configured to include three flaps 123, one on either end of the lower rear wing 124, and one between the two thrusting motors mounted to the lower rear wing 124.

Opposing ends of the upper rear wing 122 may be coupled to a corner junction 131, such as the rear left corner junction 131-3 and rear right corner junction 131-4. In some implementations, like the lower rear wing, the upper rear wing 122 may include one or more flaps or ailerons, that may be used to adjust the pitch, yaw and/or roll of the UAV 100 alone or in combination with the lifting motors 106, lifting propellers 102, thrusting motors 110, thrusting propellers 112, and/or other flaps of other wings. In some implementations, the flaps may also be used as a protective shroud to further hinder access to the lifting propellers 102 by objects external to the UAV 100. For example, when the UAV 100 is moving in a vertical direction or hovering, the flaps may be extended, similar to the extending of the front flaps 127 of the front wing 120 or the flaps 123 of the lower rear wing.

The front wing 120, lower rear wing 124, and upper rear wing 122 may be positioned and sized proportionally to provide stability to the UAV while the UAV 100 is moving in a direction that includes a horizontal component. For example, the lower rear wing 124 and the upper rear wing 122 are stacked vertically such that the vertical lift vectors generated by each of the lower rear wing 124 and upper rear wing 122 are close together, which may be destabilizing during horizontal flight. In comparison, the front wing 120 is separated from the rear wings longitudinally such that the vertical lift vector generated by the front wing 120 acts together with the vertical lift vectors of the lower rear wing 124 and the upper rear wing 122, providing efficiency, stabilization and control.

In some implementations, to further increase the stability and control of the UAV 100, one or more winglets 121, or stabilizer arms, may also be coupled to and included as part of the perimeter frame 104. In the example illustrated with respect to FIG. 1, there are two front winglets 121-1 and 121-2 mounted to the underneath side of the front left corner junction 131-1 and the front right corner junction 131-2, respectively. The winglets 121 extend in a downward direction approximately perpendicular to the front wing 120 and side rails 130. Likewise, the two rear corner junctions 131-3, 131-4 are also formed and operate as winglets providing additional stability and control to the UAV 100 when the UAV 100 is moving in a direction that includes a horizontal component, such as transit flight.

The winglets 121 and the rear corner junctions 131 may have dimensions that are proportional to the length, width, and height of the UAV 100 and may be positioned based on the approximate center of gravity of the UAV 100 to provide stability and control to the UAV 100 during horizontal flight. For example, in one implementation, the UAV 100 may be approximately 64.75 inches long from the front of the UAV 100 to the rear of the UAV 100 and approximately 60.00 inches wide. In such a configuration, the front wing 120 has dimensions of approximately 60.00 inches by approximately 7.87 inches. The lower rear wing 124 has dimensions of approximately 60.00 inches by approximately 9.14 inches. The upper rear wing 122 has dimensions of approximately 60.00 inches by approximately 5.47 inches. The vertical separation between the lower rear wing and the upper rear wing is approximately 21.65 inches. The winglets 121 are approximately 6.40 inches wide at the corner junction with the perimeter frame of the UAV, approximately 5.91 inches wide at the opposing end of the winglet and approximately 23.62 inches long. The rear corner junctions 131-3, 131-4 are approximately 9.14 inches wide at the end that couples with the lower rear wing 124, approximately 8.04 inches wide at the opposing end, and approximately 21.65 inches long. The overall weight of the UAV 100 is approximately 50.00 pounds.

Coupled to the interior of the perimeter frame 104 is a central frame 107. The central frame 107 includes a hub 108 and motor arms 105 that extend from the hub 108 and couple to the interior of the perimeter frame 104. In this example, there is a single hub 108 and four motor arms 105-1, 105-2, 105-3, and 105-4. Each of the motor arms 105 extend from approximately a corner of the hub 108 and couple or terminate into a respective interior corner of the perimeter frame. In some implementations, each motor arm 105 may couple into a corner junction 131 of the perimeter frame 104. Like the perimeter frame 104, the central frame 107 may be formed of any suitable material, such as graphite, carbon fiber, aluminum, titanium, etc., or any combination thereof. In this example, the central frame 107 is formed of carbon fiber and joined at the corners of the perimeter frame 104 at the corner junctions 131. Joining of the central frame 107 to the perimeter frame 104 may be done using any one or more of the techniques discussed above for joining the components of the perimeter frame 104.

Lifting motors 106 are coupled at approximately a center of each motor arm 105 so that the lifting motor 106 and corresponding lifting propeller 102 are within the substantially rectangular shape of the perimeter frame 104. In one implementation, the lifting motors 106 are mounted to an underneath or bottom side of each motor arm 105 in a downward direction so that the propeller shaft of the lifting motor that mounts to the lifting propeller 102 is facing downward. In other implementations, as illustrated in FIG. 1, the lifting motors 106 may be mounted to a top of the motor arms 105 in an upward direction so that the propeller shaft of the lifting motor that mounts to the lifting propeller 102 is facing upward. In this example, there are four lifting motors 106-1, 106-2, 106-3, 106-4, each mounted to an upper side of a respective motor arm 105-1, 105-2, 105-3, and 105-4.

In some implementations, multiple lifting motors may be coupled to each motor arm 105. For example, while FIG. 1 illustrates a quad-copter configuration with each lifting motor mounted to a top of each motor arm, a similar configuration may be utilized for an octo-copter. For example, in addition to mounting a lifting motor 106 to an upper side of each motor arm 105, another lifting motor may also be mounted to an underneath side of each motor arm 105 and oriented in a downward direction. In another implementation, the central frame may have a different configuration, such as additional motor arms. For example, eight motor arms may extend in different directions and a lifting motor may be mounted to each motor arm.

The lifting motors may be any form of motor capable of generating enough rotational speed with the lifting propellers 102 to lift the UAV 100 and any engaged payload, thereby enabling aerial transport of the payload.

Mounted to each lifting motor 106 is a lifting propeller 102. The lifting propellers 102 may be any form of propeller (e.g., graphite, carbon fiber) and of a size sufficient to lift the UAV 100 and any payload engaged by the UAV 100 so that the UAV 100 can navigate through the air, for example, to deliver a payload to a delivery location. For example, the lifting propellers 102 may each be carbon fiber propellers having a dimension or diameter of twenty-four inches.

As discussed further below, one or more of the lifting propellers may be convertible between an operational configuration and a transit configuration. When vertical lift sufficient to vertically lift the UAV 100 is necessary, the lifting propellers are in the operational configuration and rotated by the lifting motors 106, thereby causing vertical lift to the UAV. When the UAV is navigating in a direction that includes a horizontal component, the vertical lift needed to maintain the UAV at an altitude may be generated by the airflow passing over the wings 120, 122, 124. As such, the lifting forces generated by the rotation of the lifting propellers may not be needed and, thus, to conserve power, the lifting motors 106 may stop rotation. To reduce drag from the lifting propellers 102, rather than just aligning the lifting propellers to be parallel with the direction of travel, the lifting propellers are converted to a transit configuration and aligned so that the leading edge of two or more of the propeller blades are oriented toward the direction of the transit flight. Similar to the airfoil shape of the wings, the position and alignment of the lifting propellers, when in a transit configuration, generate lift as the airflow passes over the propeller blades. The difference between a drag caused by the lifting propellers, when in the transit configuration, and the positive vertical lift generated by the lifting propellers, when in the transit configuration, is less than a drag caused by the lifting propellers if aligned parallel to the direction of the transit flight.

While the illustration of FIG. 1 shows the lifting propellers 102 all of a same size, in some implementations, one or more of the lifting propellers 102 may be different sizes and/or dimensions. Likewise, while this example includes four lifting propellers 102-1, 102-2, 102-3, 102-4, in other implementations, more or fewer propellers may be utilized as lifting propellers 102. Likewise, in some implementations, the lifting propellers 102 may be positioned at different locations on the UAV 100. In addition, alternative methods of propulsion may be utilized as either lifting motors or thrusting “motors” in implementations described herein. For example, fans, jets, turbojets, turbo fans, jet engines, internal combustion engines, and the like may be used (either with propellers or other devices) to provide lift for the UAV.

In addition to the lifting motors 106 and lifting propellers 102, the UAV 100 may also include one or more thrusting motors 110 and corresponding thrusting propellers 112. The thrusting motors and thrusting propellers may be the same or different than the lifting motors 106 and lifting propellers 102. For example, in some implementations, the thrusting propellers may be formed of carbon fiber and be approximately eighteen inches long. In other implementations, the thrusting motors may utilize other forms of propulsion to propel the UAV. For example, fans, jets, turbojets, turbo fans, jet engines, internal combustion engines, and the like may be used (either with propellers or with other devices) as the thrusting motors.

The thrusting motors and thrusting propellers may be oriented at approximately ninety degrees with respect to the perimeter frame 104 and central frame 107 of the UAV 100 and utilized to increase the efficiency of flight that includes a horizontal component. For example, during transit flight, flight that includes a horizontal component, the thrusting motors may be engaged to provide a horizontal thrust force via the thrusting propellers to propel the UAV 100 horizontally. As a result, the speed and power utilized by the lifting motors 106 may be reduced. Alternatively, in selected implementations, the thrusting motors may be oriented at an angle greater or less than ninety degrees with respect to the perimeter frame 104 and the central frame 107 to provide a combination of thrust and lift.

In the example illustrated in FIG. 1, the UAV 100 includes two thrusting motors 110-1, 110-2 and corresponding thrusting propellers 112-1, 112-2. Specifically, in the illustrated example, there is a front thrusting motor 110-1 coupled to and positioned near an approximate mid-point of the front wing 120. The front thrusting motor 110-1 is oriented such that the corresponding thrusting propeller 112-1 is positioned inside the perimeter frame 104. The second thrusting motor is coupled to and positioned near an approximate mid-point of the lower rear wing 124. The rear thrusting motor 110-2 is oriented such that the corresponding thrusting propeller 112-2 is positioned inside the perimeter frame 104.

While the example illustrated in FIG. 1 illustrates the UAV with two thrusting motors 110 and corresponding thrusting propellers 112, in other implementations, there may be fewer or additional thrusting motors and corresponding thrusting propellers. For example, in some implementations, the UAV 100 may only include a single rear thrusting motor 110 and corresponding thrusting propeller 112. In another implementation, there may be two thrusting motors and corresponding thrusting propellers mounted to the lower rear wing 124. In such a configuration, the front thrusting motor 110-1 may be included or omitted from the UAV 100. Likewise, while the example illustrated in FIG. 1 shows the thrusting motors oriented to position the thrusting propellers inside the perimeter frame 104, in other implementations, one or more of the thrusting motors 110 may be oriented such that the corresponding thrusting propeller 112 is oriented outside of the protective frame 104.

The perimeter frame 104 provides safety for objects foreign to the UAV 100 by inhibiting access to the lifting propellers 102 from the side of the UAV 100, provides protection to the UAV 100, and increases the structural integrity of the UAV 100. For example, if the UAV 100 is traveling horizontally and collides with a foreign object (e.g., wall, building), the impact between the UAV 100 and the foreign object will be with the perimeter frame 104, rather than a propeller. Likewise, because the frame is interconnected with the central frame 107, the forces from the impact are dissipated across both the perimeter frame 104 and the central frame 107.

The perimeter frame 104 also provides a surface upon which one or more components of the UAV 100 may be mounted. Alternatively, or in addition thereto, one or more components of the UAV may be mounted or positioned within the cavity of the portions of the perimeter frame 104. For example, antennas may be included in the cavity of the perimeter frame and be used to transmit and/or receive wireless communications. The antennas may be utilized for Wi-Fi, satellite, near field communication (“NFC”), cellular communication, or any other form of wireless communication. Other components, such as cameras, time of flight sensors, accelerometers, inclinometers, distance-determining elements, gimbals, Global Positioning System (GPS) receiver/transmitter, radars, illumination elements, speakers, and/or any other component of the UAV 100 or the UAV control system (discussed below), etc., may likewise be mounted to or in the perimeter frame 104. Likewise, identification or reflective identifiers may be mounted to the perimeter frame 104 to aid in the identification of the UAV 100.

In some implementations, the perimeter frame 104 may also include a permeable material (e.g., mesh, screen) that extends over the top and/or lower surface of the perimeter frame 104 enclosing the central frame, lifting motors, and/or lifting propellers.

A UAV control system 114 is also mounted to the central frame 107. In this example, the UAV control system 114 is mounted to the hub 108 and is enclosed in a protective barrier. The protective barrier may provide the control system 114 weather protection so that the UAV 100 may operate in rain and/or snow without disrupting the control system 114. In some implementations, the protective barrier may have an aerodynamic shape to reduce drag when the UAV is moving in a direction that includes a horizontal component. The protective barrier may be formed of any materials including, but not limited to, graphite-epoxy, Kevlar, and/or fiberglass. In some implementations, multiple materials may be utilized. For example, Kevlar may be utilized in areas where signals need to be transmitted and/or received.

Likewise, the UAV 100 includes one or more power modules. The power modules may be positioned inside the cavity of the side rails 130-1, 130-2. In other implementations, the power modules may be mounted or positioned at other locations of the UAV. The power modules for the UAV may be in the form of battery power, solar power, gas power, super capacitor, fuel cell, alternative power generation source, or a combination thereof. For example, the power modules may each be a 6000 mAh lithium-ion polymer battery, or polymer lithium ion (Li-poly, Li-Pol, LiPo, LIP, PLI or Lip) battery. The power module(s) are coupled to and provide power for the UAV control system 114, the lifting motors 106, the thrusting motors 110, and the payload engagement mechanism (not shown).

In some implementations, one or more of the power modules may be configured such that it can be autonomously removed and/or replaced with another power module while the UAV is landed or in flight. For example, when the UAV lands at a location, the UAV may engage with a charging member at the location that will recharge the power module.

As mentioned above, the UAV 100 may also include a payload engagement mechanism. The payload engagement mechanism may be configured to engage and disengage items and/or containers that hold items (payload). In this example, the payload engagement mechanism is positioned beneath and coupled to the hub 108 of the frame 104 of the UAV 100. The payload engagement mechanism may be of any size sufficient to securely engage and disengage a payload. In other implementations, the payload engagement mechanism may operate as the container in which it contains item(s). The payload engagement mechanism communicates with (via wired or wireless communication) and is controlled by the UAV control system 114. Example payload engagement mechanisms are described in co-pending patent application Ser. No. 14/502,707, filed Sep. 30, 2014, titled “UNMANNED AERIAL VEHICLE DELIVERY SYSTEM,” the subject matter of which is incorporated by reference herein in its entirety.

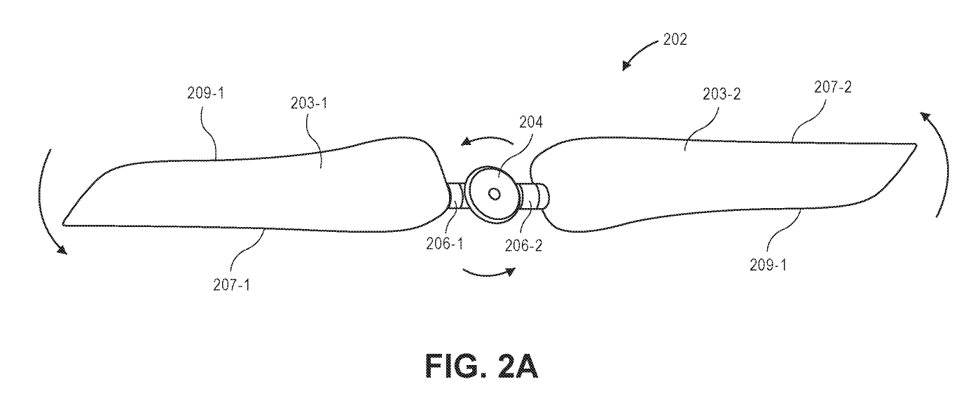

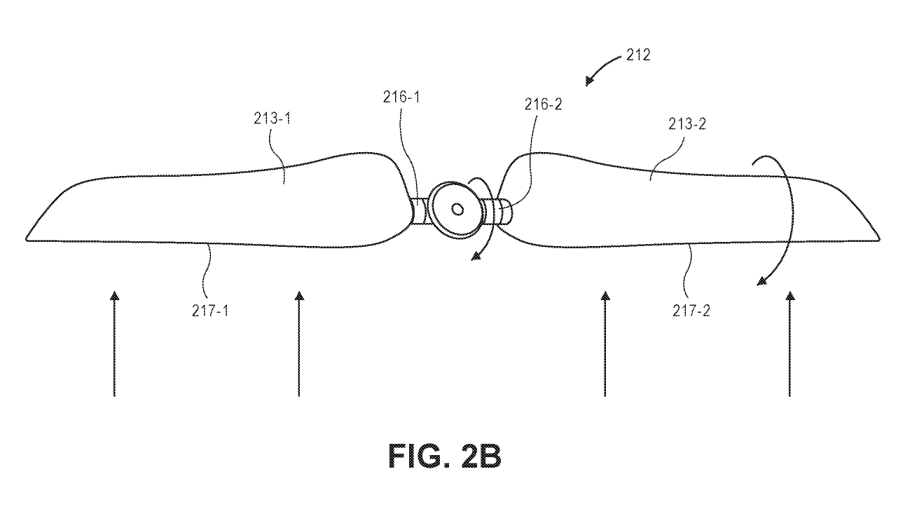

FIG. 2A illustrates an example lifting propeller 202 in an operational configuration, according to an implementation. The lifting propeller 202 includes a first adjustable blade 203-1 and a second adjustable blade 203-2, both of which are mounted about a hub 204 and extend in opposite directions from the hub 204. Both adjustable blades are mounted to the hub 204 via a rotatable member 206-1, 206-2. The rotatable member may be any type of mechanism that will allow rotation of the adjustable blade 203 with respect to the hub 204. For example, the rotatable member 206 may be a gear drive or screw drive that when rotated will rotate the blade 203.

Each blade 203-1, 203-2 has an airfoil shape for generating lift when the lifting propeller 202 is in the illustrated operational configuration and is rotated about an axis defined by the hub 204, e.g., by a mast of a motor transmission provided on an aerial vehicle (not shown). For example, as is shown in FIG. 2A, the adjustable blades 203 each define airfoils having rounded leading edges 207-1, 207-2 and pointed trailing edges 209-1, 209-2, which may include upper surfaces or lower surfaces having symmetrical or asymmetrical shapes or cross-sectional areas. The airfoil shapes defined by the blades 203, and the angles at which the blades 203 are mounted to the hub 204, via the rotatable members 206, may be selected based on an amount of lift desired to be provided by the lifting propeller 202. Likewise, the angle of attack of the blades 203 may be altered by adjusting one or more of the rotatable members 206-1, 206-2.

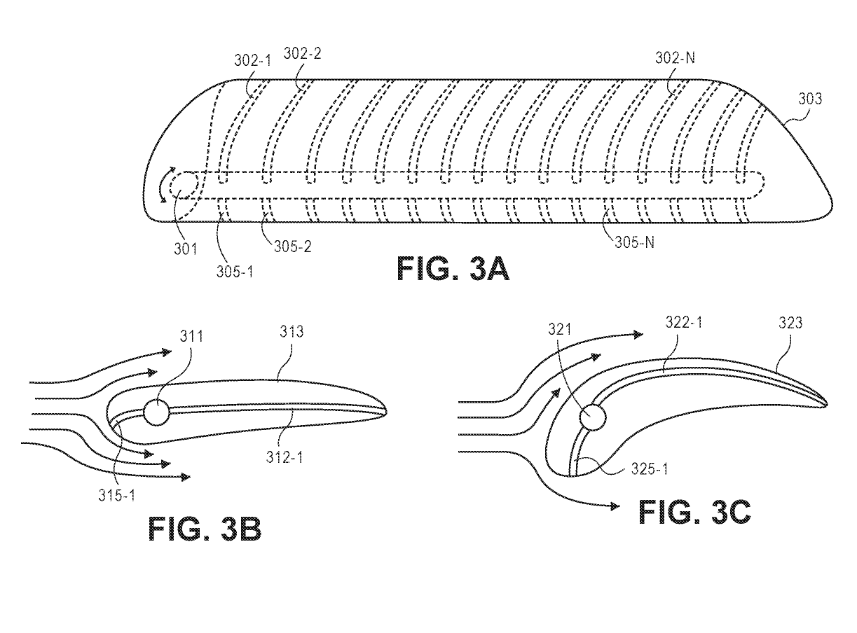

The various components of the lifting propeller 202 may be formed from any suitable materials that may be selected based on an amount of lift that may be desired when the lifting propeller 202 is in an operational configuration. In some implementations, the blades 203 may be designed to optimize for positive lift when in the operational configuration and to generate lift or limited drag when the lifting propeller 202 is in the transit configuration, illustrated and discussed below with respect to FIG. 2B. In some implementations, aspects of the blades 203-1, 203-2, and/or the hub 204 may be formed from one or more plastics (e.g., thermosetting plastics such as epoxy or phenolic resins, polyurethanes or polyesters, as well as polyethylenes, polypropylenes or polyvinyl chlorides), wood (e.g., woods with sufficient strength properties such as ash), metals (e.g., lightweight metals such as aluminum, or metals of heavier weights including alloys of steel), composites or any other combinations of materials. In some implementations, the aspects of the blades 203 may be formed of one or more lightweight materials including but not limited to carbon fiber, graphite, machined aluminum, titanium, or fiberglass. In some implementations, the airfoil shape of the blade may be dynamically adjustable, as illustrated and discussed below with respect to FIGS. 3A-3C.

Furthermore, in some implementations, the various components of the lifting propeller 202 may be formed by modifying a standard propeller of any type, size, shape or form by coupling the standard propeller blades to the hub using one or more rotatable members 206-1, 206-2. In other implementations, the blades may be formed to have a larger shape and thus larger moment of inertia. In such a configuration, the blades will provide more lift when in the transit configuration, yet still provide positive vertical lift when rotated and in the rotatable configuration.

The various components of the lifting propeller 202 may be reinforced with one or more materials for providing protection against wear that may be experienced during operation, including but not limited to wear caused by rotating or pivoting contact between ends of the blades 203 and the rotatable members 206. Such ends may be reinforced through lamination or sealing by caps, shoulders, strips or other components (not shown) formed from materials (e.g., fiberglass) that are more durable or friction-resistant than the blades 203. Such components may also be lined with or otherwise feature frictionless or low-friction contact materials which reduce or minimize friction that may resist rotation about the shaft assembly. Such frictionless or low-friction contact materials may include solid materials such as polytetrafluoroethylene, e.g., Teflon®, liquid substances such as greases or oils, powdered substances such as graphite, or a combination of solid, liquid and/or powdered materials. In other implementations, the connection between the rotatable members 206 and the blades 203 may be gear driven such that, as the rotatable member turns, the gears connecting the blade 203 to the rotatable member 206 cause the blade to rotate.

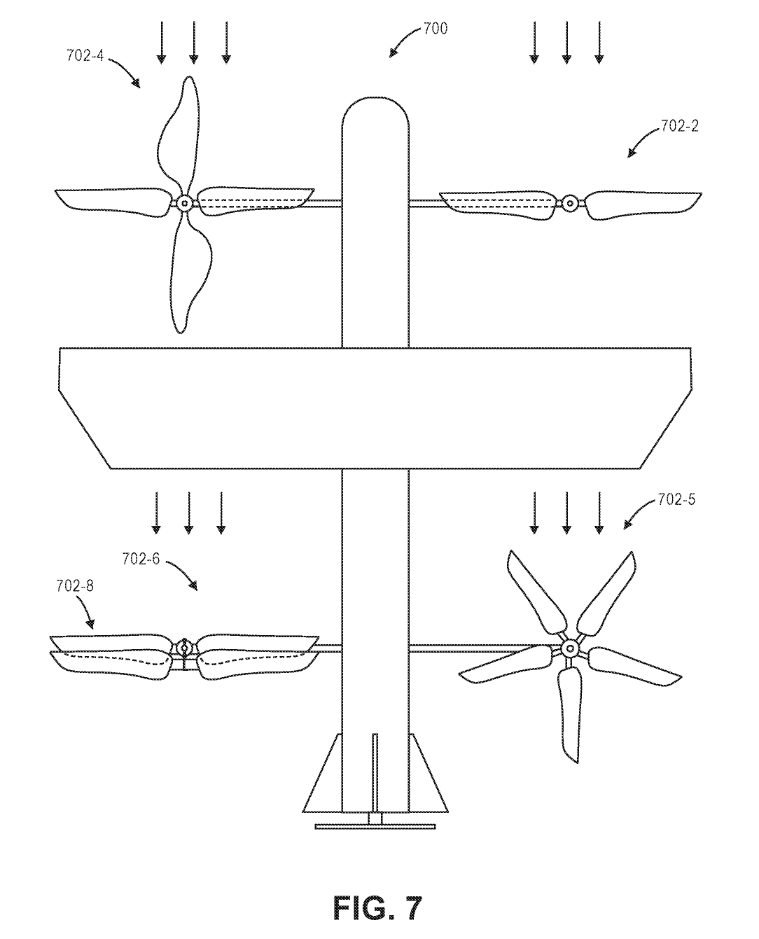

FIG. 2B illustrates the example lifting propeller 202 of FIG. 2A in the transit configuration, according to an implementation. In this example, the adjustable blade 213-2 has been rotated approximately one-hundred and eighty degrees by rotation of the rotatable member 216-2 so that the leading edge 217-2 is aligned and positioned in the same direction as the leading edge 217-1 of the blade 213-1. By aligning the leading edge 217-1, 217-2 of each blade 213-1, 213-2 of the lifting propeller 212 in the same direction, when the lifting propeller is oriented in the direction of transit flight of the UAV, the airflow passing over the blades 213 will cause lift by the airfoil shape of the blades 213. For example, referring to FIG. 7, the lifting propeller 702-2, which corresponds to the lifting propeller 212 of FIG. 2B, is in the transit configuration and oriented such that the leading edge of each blade is positioned approximately perpendicular to the airflow caused by the direction of horizontal flight of the UAV 700.

By converting the lifting propeller into the transit configuration and orienting the leading edge of the blades toward the direction of flight, a positive vertical lift is generated from airflow passing over the blades. The energy saved from the additional positive vertical lift that is produced by positioning the blades in this configuration is greater than the energy consumed from drag caused by orienting the leading edge of the blades toward the direction of flight. This energy difference is referred to herein as the net energy saved.

Likewise, the net energy saved by converting the propellers into the transit configuration and aligning the leading edges of the propeller blades toward the direction of flight is greater than the net energy saved by aligning the propeller approximately parallel to the direction of the transit flight.

In some implementations, as illustrated in FIGS. 3A-3C, the airfoil shape of the propeller blades of the lifting propeller may be dynamically adjustable, according to an implementation. For example, the propeller blade 303 may be substantially hollow, e.g., with a solid skin defining an airfoil having a hollow cavity therein, with one or more internal supports 301, 302, 305 or structural features for maintaining and/or altering the shape of the airfoil. For example, the blade 303 or portions thereof may be formed from durable frames of stainless steel, carbon fibers, or other similarly lightweight, rigid materials and reinforced with radially aligned fiber tubes or struts. Utilizing a blade 303 having a substantially hollow cross-section thereby reduces the mass of the lifting propeller, and enables wiring, cables and other conductors or connectors to be passed there through, and in communication with one or more other control systems components or features. Likewise, the support arms, such as the spine 301, trailing edge ribs 302, and/or leading edge ribs 305 may be adjustable to thereby alter a shape of the airfoil. (The spine, trailing edge ribs, and leading edge ribs will be referred to herein collectively as support arms). For example, referring to FIG. 3B, when the spine 311, which illustrates a cross-sectional view of the spine 301 of FIG. 3A, is in a first position, leading edge ribs 315-1, and trailing edge ribs 312-1 are in a first position and the airfoil shape of the blade 313, which is a cross-sectional view of the blade 303 (FIG. 3A), has a first shape. If the airfoil shape of the blade is to be altered, the spine 301 may be rotated, as illustrated in FIG. 3C. In this example, the spine 321, which is a cross-sectional view of the spine 301 (FIG. 3A), is rotated, which causes the leading edge rib 325-1 and trailing edge rib 322-1 to bend or curve due to the forces acting on the support arms from the external solid skin of the blade 323. As the ribs 322-1, 325-1 bend or curve, the airfoil shape of the blade 323, which is a cross-section view of the blade 303, also changes.

Returning to FIG. 3A, depending on the quantity, shape and/or position of the support arms 302 and 305, and the couple points between the leading edge ribs 305 and/or trailing edge ribs 302 with the spine 301, the airfoil shape of the blade 303 may be different at different sections of the blade. As illustrated, any number of trailing edge ribs 302-1, 302-2-302-N may be included in the blade 303 and define the airfoil shape of a portion of the blade 303 depending on the curvature of the trailing edge ribs 302 and the position along the spine 301 to which they are coupled. Likewise, as illustrated, any number of leading edge ribs 305-1, 305-2-305-N may be included in the blade 303 and define the airfoil shape of a portion of the blade 303 depending on the curvature of the leading edge ribs 305 and the position of the spine 301 to which they are coupled. The quantity, size, shape, position, etc., may vary between trailing edge ribs 302 and/or leading edge ribs 305.

In some implementations, when the lifting propeller is in an operational configuration, the airfoil shape of the blades of the lifting propeller may be altered to have a shape similar to that illustrated in FIG. 3C. The shape in FIG. 3C, even though causing more drag, generates an increased positive lifting force. Because the blades of the lifting propeller are rotating, the energy saved by the airfoil shape that generates the positive lifting force is greater than the energy consumed by the drag caused by the airfoil shape. In comparison, when the lifting propeller is in a transit configuration, the airfoil shape of the blades of the lifting propeller may be altered to have a shape similar to that illustrated in FIG. 3B. In comparison to the airfoil shape illustrated in FIG. 3C, the airfoil shape illustrated in FIG. 3B generates less lift but also produces less drag. Because the lifting propellers are not rotating when in the transit configuration, the lower amount of drag reduces the consumed energy such that the energy consumed by the drag of the propeller remains lower than the energy saved by the lift produced by the blades when in the transit configuration.

In still other implementations, a thickness of the propeller blade 303 may be altered. For example, an inflatable bladder or other membrane may be included in the hollow cavity of the propeller blade. If the thickness of the propeller blade 303 is to be increased, the bladder is inflated a desired amount, thereby causing the external skin to expand and increase the thickness of the propeller blade. In a similar manner, if the thickness of the propeller blade 303 is to be decreased, the bladder is deflated a desired amount.

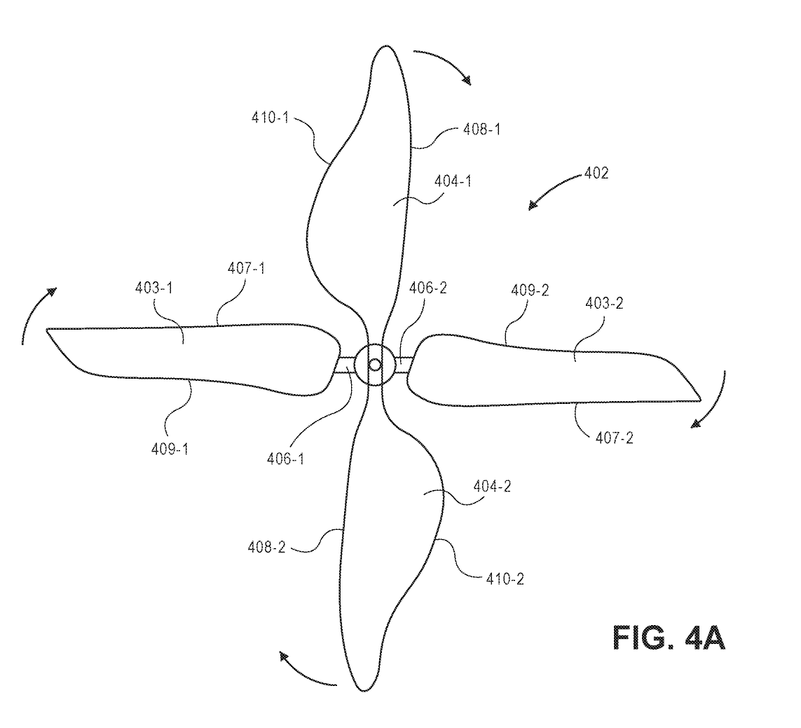

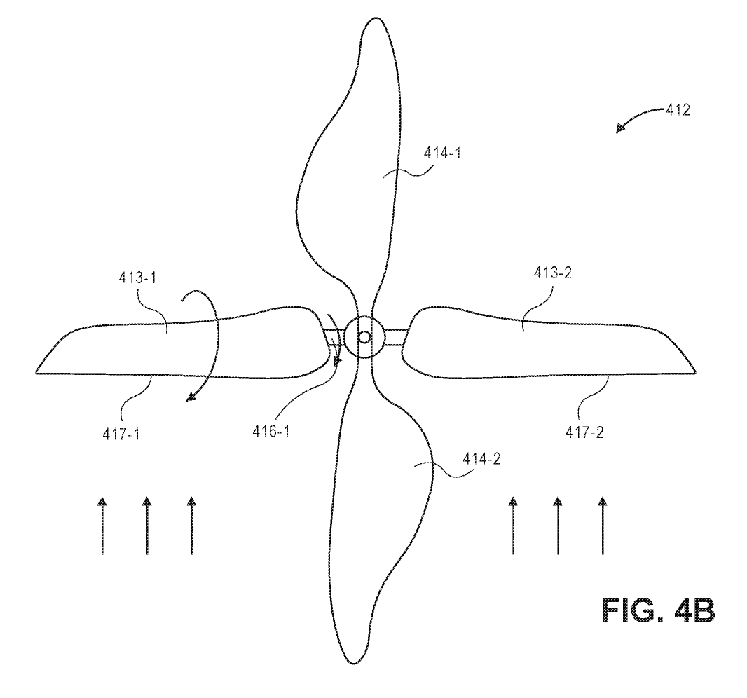

FIG. 4A depicts a view of a lifting propeller 402 in an operational configuration, according to an implementation. The lifting propeller 402 includes a first adjustable blade 403-1 and a second adjustable blade 403-2, both of which are mounted about a hub and extend in opposite directions from the hub. Similar to the discussion above with respect to FIG. 2A, both adjustable blades are mounted to the hub via a rotatable member 406-1, 406-2. In addition to adjustable blades 403, the lifting propeller 402 illustrated in FIG. 4A includes two fixed blades 404-1 and 404-2. The fixed blades 404-1, 404-2 are also coupled to the hub and extend in opposite directions. In this example, the fixed blades 404 are oriented approximately perpendicular, or ninety degrees out of phase alignment, to the adjustable blades 403. In other implementations, there may be fewer or additional fixed blades, fewer or additional adjustable blades, and/or the orientation of the blades may vary.

Each blade 403-1, 403-2, 404-1, 404-2 has an airfoil shape for generating lift when the lifting propeller 402 is in the illustrated operational configuration and is rotated about an axis defined by the hub, e.g., by a mast of a motor transmission provided on an aerial vehicle (not shown). For example, as is shown in FIG. 4A, the adjustable blades 403 and fixed blades each define airfoils having rounded leading edges 407-1, 407-2, 408-1, and 408-2 and pointed trailing edges 409-1, 409-2, 410-1, 410-2, which may include upper surfaces or lower surfaces having symmetrical or asymmetrical shapes or cross-sectional areas. The airfoil shapes defined by the blades 403, and the angles at which the blades 403 are mounted to the hub, via the rotatable members 406-1, 406-2, may be selected based on an amount of lift desired to be provided by the lifting propeller 402. Likewise, the angle or pitch of the blades 403 may be altered by adjusting one or more of the rotatable members 406-1, 406-2. In comparison, the airfoil shapes defined by the blades 404, and the angles at which the blades 404 are mounted to the hub, may be different than the angles or shapes of adjustable blades 403. For example, because in this example the fixed blades 404-1, 404-2 are aligned parallel with the direction of transit flight when the lifting propeller 402 is in a transit configuration, as illustrated in FIG. 4B, the lift generated by the fixed blades during transit flight is reduced. As such, the shape and/or angle of the fixed blades 404 may be selected to optimize for lift generated when the lifting propeller is in the operational configuration and/or selected to reduce drag from the fixed blades 404 when the lifting propeller is in the transit configuration.

Like the discussion provided with respect to FIGS. 2A-2B, the various components of the lifting propeller 402 may be formed from any suitable materials that may be selected based on an amount of lift that may be desired when the lifting propeller 402 is in a operational configuration. In some implementations, the rotational blades 403 may be designed to optimize for positive lift when in the operational configuration and to generate lift or limited drag when the lifting propeller 402 is in the transit configuration, illustrated and discussed below with respect to FIG. 4B. Likewise, the fixed blades 404-1, 404-2 may be designed to optimize for positive lift when in the operational configuration and to produce limited drag when the lifting propeller 402 is in the transit configuration.

In some implementations, aspects of the rotational blades 403-1, 403-2, the fixed blades 404-1, 404-2, and/or the hub may be formed from one or more plastics (e.g., thermosetting plastics such as epoxy or phenolic resins, polyurethanes or polyesters, as well as polyethylenes, polypropylenes or polyvinyl chlorides), wood (e.g., woods with sufficient strength properties such as ash), metals (e.g., lightweight metals such as aluminum, or metals of heavier weights including alloys of steel), composites or any other combinations of materials. In some implementations, the aspects of the blades 403, 404 may be formed of one or more lightweight materials including but not limited to carbon fiber, graphite, machined aluminum, titanium, or fiberglass. In some implementations, the airfoil shape of the adjustable blades 403-1, 403-2 may be dynamically adjustable, as illustrated and discussed above with respect to FIGS. 3A-3C.

FIG. 4B illustrates the example lifting propeller 402 of FIG. 4A in the transit configuration, according to an implementation. In this example, the adjustable blade 413-1 has been rotated approximately one-hundred and eighty degrees by rotation of the rotatable member 416-1 so that the leading edge 417-1 is aligned and positioned in the same direction as the leading edge 417-2 of the blade 413-2. By aligning the leading edge 417-1, 417-2 of each blade 413-1, 413-2 of the lifting propeller 412 in the same direction, when the lifting propeller is oriented into the wind or in the direction of transit flight of the UAV, the airflow passing over the adjustable blades 413 will cause lift by the airfoil shape of the blades 413. Likewise, because the fixed blades 414-1 and 414-2 are approximately perpendicular to the rotational blades 413-1, 413-2, the fixed blades are oriented approximately parallel to the direction of the transit flight, thereby reducing any drag generated by the fixed blades.

For example, referring to FIG. 7, the lifting propeller 702-4, which corresponds to the lifting propeller 412 of FIG. 4B, is in the transit configuration and oriented such that the leading edge of each adjustable blade is positioned approximately perpendicular to the airflow caused by the direction of horizontal flight of the UAV 700. Likewise, when the lifting propeller 702-2 is in the transit configuration, it is oriented such that the fixed blades are approximately parallel to the direction of the horizontal flight of the UAV 700 and thus reducing any drag generated by those fixed propellers.

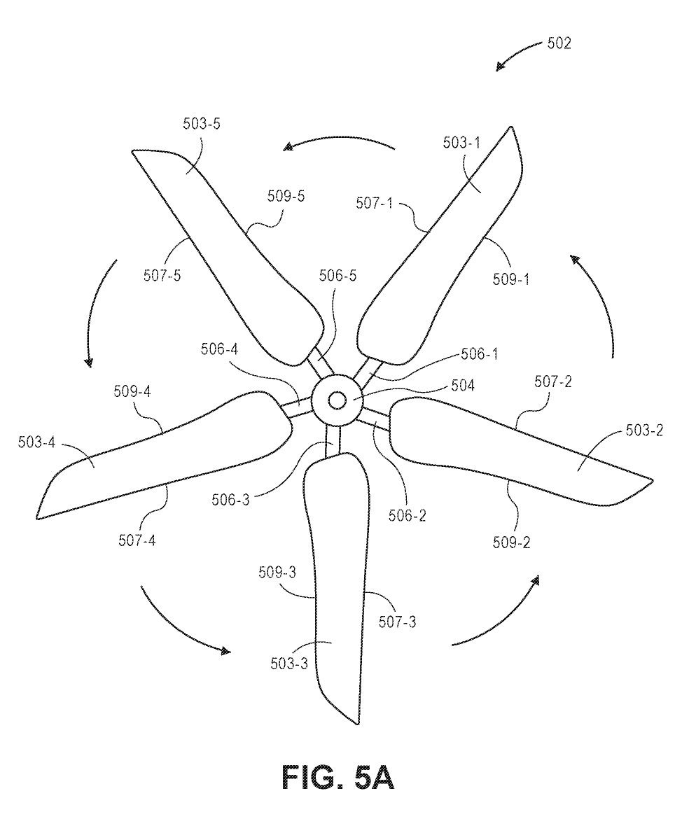

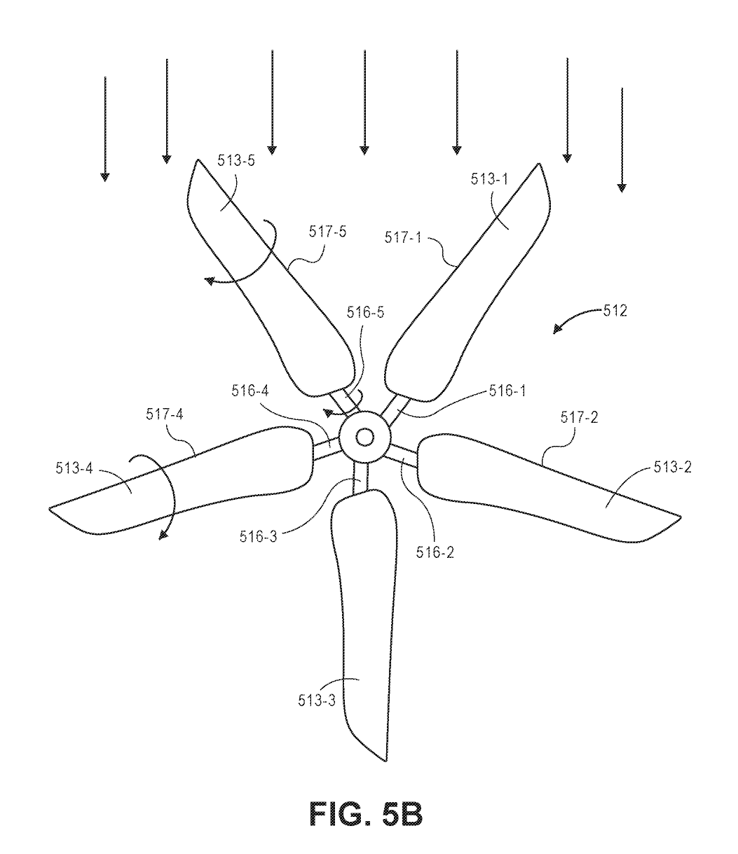

FIG. 5A depicts a view of a lifting propeller 502 in an operational configuration, according to an implementation. The lifting propeller 502 includes five adjustable blades 503-1, 503-2, 503-3, 503-4, and 503-5, each of which are mounted about a hub 504 and extend in from the hub 504. Similar to the discussion above with respect to FIG. 2A, each of the adjustable blades are mounted to the hub 504 via a rotatable member 506-1, 506-2, 506-3, 506-4, and 506-5. While this example includes five adjustable blades, in some implementations, one or more of the blades may be a fixed blade, similar to the fixed blades discussed above with respect to FIG. 4A.

Each blade 503-1, 503-2, 503-3, 503-4, and 503-5 has an airfoil shape for generating lift when the lifting propeller 502 is in the illustrated operational configuration and is rotated about an axis defined by the hub, e.g., by a mast of a motor transmission provided on an aerial vehicle (not shown). For example, as is shown in FIG. 5A, the adjustable blades 503 each define airfoils having rounded leading edges 507-1, 507-2, 507-3, 507-4, and 507-5 and pointed trailing edges 509-1, 509-2, 509-3, 509-4, and 509-5 which may include upper surfaces or lower surfaces having symmetrical or asymmetrical shapes or cross-sectional areas. The airfoil shapes defined by the blades 503, and the angles at which the blades 503 are mounted to the hub, via the rotatable members 506-1, 506-2, 506-3, 506-4, and 506-5, may be selected based on an amount of lift desired to be provided by the lifting propeller 502. Likewise, the angle or pitch of the blades 503 may be altered by adjusting one or more of the rotatable members 506-1, 506-2, 506-3, 506-4, and 506-5.

Like the discussion provided with respect to FIGS. 2A-2B, the various components of the lifting propeller 502 may be formed from any suitable materials that may be selected based on an amount of lift that may be desired when the lifting propeller 502 is in a operational configuration. In some implementations, the rotational blades 503 may be designed to optimize for positive lift when in the operational configuration and to generate lift or limited drag when the lifting propeller 502 is in the transit configuration, illustrated and discussed below with respect to FIG. 5B.

In some implementations, aspects of the rotational blades 503-1, 503-2, 503-3, 503-4, and 503-5, and/or the hub may be formed from one or more plastics (e.g., thermosetting plastics such as epoxy or phenolic resins, polyurethanes or polyesters, as well as polyethylenes, polypropylenes or polyvinyl chlorides), wood (e.g., woods with sufficient strength properties such as ash), metals (e.g., lightweight metals such as aluminum, or metals of heavier weights including alloys of steel), composites or any other combinations of materials. In some implementations, the aspects of the blades 503 may be formed of one or more lightweight materials including but not limited to carbon fiber, graphite, machined aluminum, titanium, or fiberglass. In some implementations, the airfoil shape of the adjustable blades 503-1, 503-2, 503-3, 503-4, and 503-5 may be dynamically adjustable, as illustrated and discussed above with respect to FIGS. 3A-3C.

FIG. 5B illustrates the example lifting propeller 502 of FIG. 5A in the transit configuration, according to an implementation. In this example, two of the adjustable blades 513-5 and 513-4 have been rotated approximately one-hundred and eighty degrees by rotation of the rotatable members 516-5 and 516-4 so that the leading edges 517-5 and 517-4 are aligned and positioned into the direction of airflow from a transit flight, as are the leading edges 517-1, 517-2 of blades 513-1, 513-2. Because blade 513-3 is positioned to be approximately parallel with the direction of the transit flight, the blade may not be rotated as the drag generated by blade 513-3 is limited. By aligning the leading edges 517-1, 517-2, 517-4, and 517-5 of the blades 513-1, 513-2, 513-4, and 513-5 of the lifting propeller 512 so that the leading edges are directed into the airflow generated by a transit flight of the UAV, the airflow passing over the adjustable blades 513-1, 513-2, 513-4, and 513-5 will cause lift by the airfoil shape of the blades 513-1, 513-2, 513-4, and 513-5. Likewise, because blade 513-3 is oriented approximately parallel to the direction of the transit flight, the drag reduced by the blade 513-3 is reduced.

For example, referring to FIG. 7, the lifting propeller 702-5, which corresponds to the lifting propeller 512 of FIG. 5B, is in the transit configuration and oriented such that the leading edge of four of the adjustable blades are oriented into the airflow of the wind, and one of the adjustable blades is positioned approximately parallel to the direction of the horizontal flight of the UAV 700.

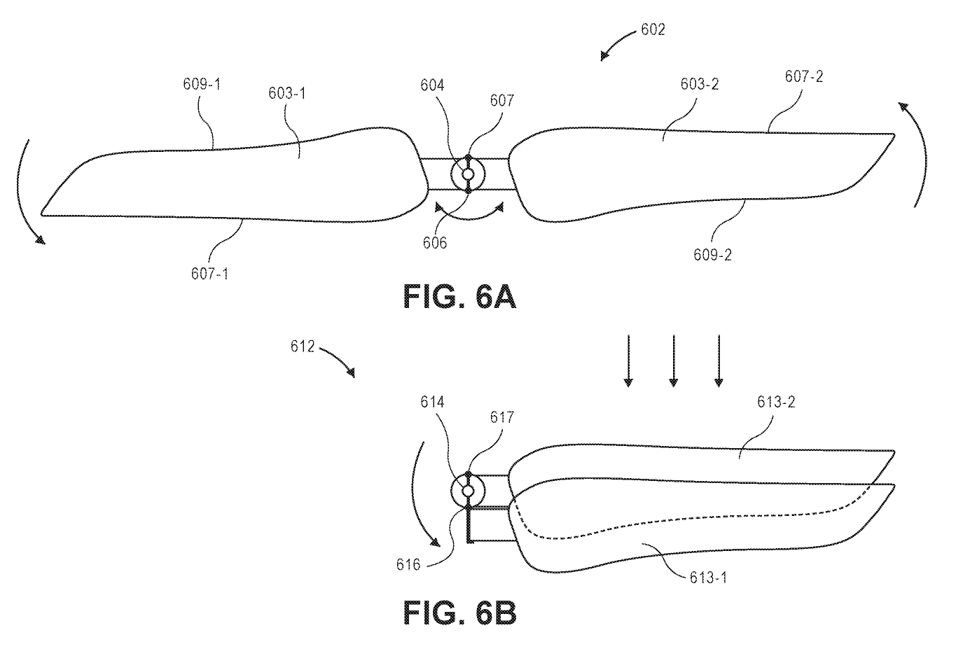

FIG. 6A depicts a view of a lifting propeller 602 in an operational configuration, according to an implementation. The lifting propeller 602 includes a first adjustable blade 603-1 and a second adjustable blade 603-2 both of which are mounted about a hub 604 and extend in opposite directions from the hub 604. In this example, the rotatable member 607 is in the form of a hinge and latch that are configured to hold the adjustable blade in the position illustrated in FIG. 6A when the lifting propeller is in a rotatable configuration. However, when the latch is released, the rotatable member allows or enables the rotation of one of the adjustable blades about the hinge such that the two blades are oriented on the same side of the hub and extend in substantially the same direction, as illustrated in FIG. 6B and discussed further below. In some implementations, the rotatable member may also include a vertical adjustment component, such as a screw drive, vertical offset, etc. that causes a blade to move vertically as it rotates about the hinge. In such an implementation, when a blade is rotated into the transit configuration, the two blades are oriented on the same side of the hub, extend in substantially the direction, and are vertically offset from one another by a defined distance.

Each blade 603-1, 603-2 has an airfoil shape for generating lift when the lifting propeller 602 is in the illustrated operational configuration and is rotated about an axis defined by the hub, e.g., by a mast of a motor transmission provided on an aerial vehicle (not shown). For example, as is shown in FIG. 6A, the adjustable blades 603 each define airfoils having rounded leading edges 607-1, 607-2 and pointed trailing edges 609-1, 609-2, which may include upper surfaces or lower surfaces having symmetrical or asymmetrical shapes or cross-sectional areas. The airfoil shapes defined by the blades 603, and the angles at which the blades 603 are mounted to the hub may be selected based on an amount of lift desired to be provided by the lifting propeller 602. In some implementations, the rotatable member may also include a second rotational component that allows the pitch of the blades to be altered.

Like the discussion provided with respect to FIGS. 2A-2B, the various components of the lifting propeller 602 may be formed from any suitable materials that may be selected based on an amount of lift that may be desired when the lifting propeller 602 is in a operational configuration. In some implementations, the rotational blades 603 may be designed to optimize for positive lift when in the operational configuration and to generate lift or limited drag when the lifting propeller 602 is in the transit configuration, illustrated and discussed below with respect to FIG. 6B.

In some implementations, aspects of the rotational blades 603-1, 603-2, and/or the hub may be formed from one or more plastics (e.g., thermosetting plastics such as epoxy or phenolic resins, polyurethanes or polyesters, as well as polyethylenes, polypropylenes or polyvinyl chlorides), wood (e.g., woods with sufficient strength properties such as ash), metals (e.g., lightweight metals such as aluminum, or metals of heavier weights including alloys of steel), composites or any other combinations of materials. In some implementations, the aspects of the blades 603 may be formed of one or more lightweight materials including but not limited to carbon fiber, graphite, machined aluminum, titanium, or fiberglass. In some implementations, the airfoil shape of the adjustable blades 603-1, 603-2 may be dynamically adjustable, as illustrated and discussed above with respect to FIGS. 3A-3C.

FIG. 6B illustrates the example lifting propeller 602 of FIG. 6A in the transit configuration, according to an implementation. In this example, the clasp 617 of the hinge has been released and the adjustable blade 613-1 has rotated about the hinge 616 so that the blade 613-1 is extending in the same direction as blade 613-2. In some implementations, the rotatable member may include a gear or drive mechanism that causes the adjustable blade to move from the rotatable position to the transit position. In other implementations, the lifting propeller may include a spring that causes the adjustable blade 613-1 to rotate to the transit position when the clasp 617 is released. Likewise, when the rotation of the lifting motor resumes, causing the lifting propeller to rotate, the adjustable blade 613-1 may rotate back to the rotatable position due to the centrifugal force applied to the blade from the rotation by the lifting motor.

The two adjustable blades 613-2, 613-1 may partially or wholly overlap and, because of the rotation, the leading edge 617-1, 617-2 of each blade are aligned and oriented toward a direction of airflow when the UAV is in transit flight. As noted above, in some implementations, the rotatable member may also include a vertical offset that causes the blade to move vertically as it rotates about the hinge. By aligning the leading edge 617-1, 617-2 of each blade 613-1, 613-2 of the lifting propeller 612 in the same direction, when the lifting propeller is oriented in the direction of transit flight of the UAV, the airflow passing over the adjustable blades 613 will cause lift by the airfoil shape of the blades 613.

For example, referring to FIG. 7, the lifting propeller 702-6, which corresponds to the lifting propeller 612 of FIG. 6B, is in the transit configuration and oriented such that the leading edge of each adjustable blade is positioned approximately perpendicular to the airflow caused by the direction of horizontal flight of the UAV 700. In some implementations, the UAV may include a stacked pair of lifting propellers that are configured similar to those discussed with respect to FIG. 6A-6B. In such a configuration, one set of the stacked pair of lifting propellers may transition to the transit configuration and be oriented in one direction, such as lifting propeller 702-6, and the other pair may transition to the transit configuration and be oriented in a second, opposite direction, such as lifting propeller 702-8. When both pairs of stacked propellers 702-6 and 702-8 are in the transit configuration and aligned as illustrated, they form a paired wing shape configuration, as illustrated in FIG. 7.

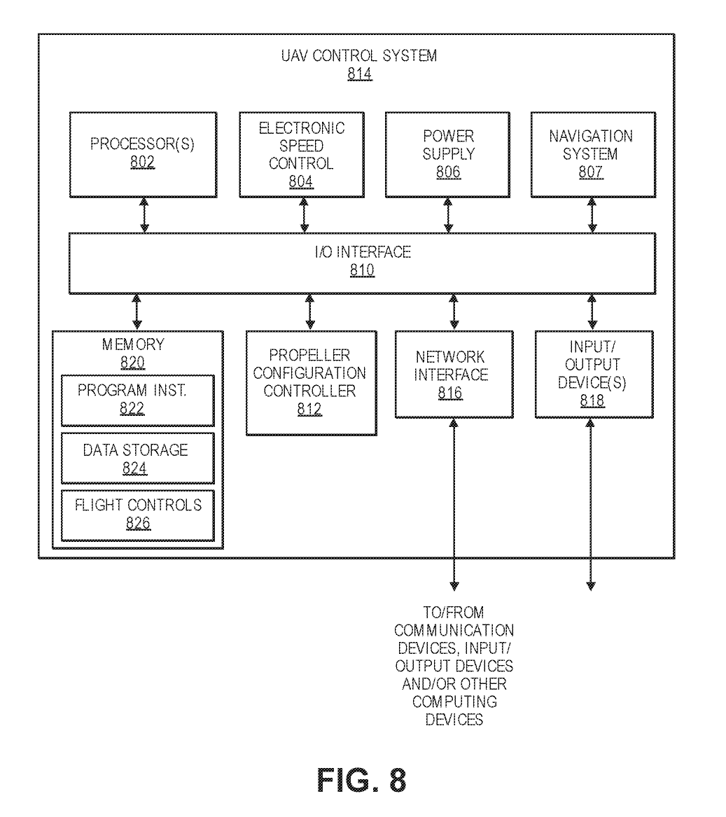

FIG. 8 is a block diagram illustrating an example UAV control system 814. In various examples, the block diagram may be illustrative of one or more aspects of the UAV control system 114 that may be used to implement the various systems and methods discussed herein and/or to control operation of the UAVs described herein. In the illustrated implementation, the UAV control system 814 includes one or more processors 802, coupled to a memory, e.g., a non-transitory computer readable storage medium 820, via an input/output (I/O) interface 810. The UAV control system 814 may also include electronic speed controls 804 (ESCs), power supply modules 806, a navigation system 807, and/or a propeller configuration controller 812. In some implementations, the navigation system 807 may include an inertial measurement unit (IMU). The UAV control system 814 may also include a network interface 816, and one or more input/output devices 818.

In various implementations, the UAV control system 814 may be a uniprocessor system including one processor 802, or a multiprocessor system including several processors 802 (e.g., two, four, eight, or another suitable number). The processor(s) 802 may be any suitable processor capable of executing instructions. For example, in various implementations, the processor(s) 802 may be general-purpose or embedded processors implementing any of a variety of instruction set architectures (ISAs), such as the x86, PowerPC, SPARC, or MIPS ISAs, or any other suitable ISA. In multiprocessor systems, each processor(s) 802 may commonly, but not necessarily, implement the same ISA.

The non-transitory computer readable storage medium 820 may be configured to store executable instructions, data, flight paths, flight control parameters, and/or data items accessible by the processor(s) 802. In various implementations, the non-transitory computer readable storage medium 820 may be implemented using any suitable memory technology, such as static random access memory (SRAM), synchronous dynamic RAM (SDRAM), nonvolatile/Flash-type memory, or any other type of memory. In the illustrated implementation, program instructions and data implementing desired functions, such as those described herein, are shown stored within the non-transitory computer readable storage medium 820 as program instructions 822, data storage 824 and flight controls 826, respectively. In other implementations, program instructions, data, and/or flight controls may be received, sent, or stored upon different types of computer-accessible media, such as non-transitory media, or on similar media separate from the non-transitory computer readable storage medium 820 or the UAV control system 814. Generally speaking, a non-transitory, computer readable storage medium may include storage media or memory media such as magnetic or optical media, e.g., disk or CD/DVD-ROM, coupled to the UAV control system 814 via the I/O interface 810. Program instructions and data stored via a non-transitory computer readable medium may be transmitted by transmission media or signals, such as electrical, electromagnetic, or digital signals, which may be conveyed via a communication medium such as a network and/or a wireless link, such as may be implemented via the network interface 816.

In one implementation, the I/O interface 810 may be configured to coordinate I/O traffic between the processor(s) 802, the non-transitory computer readable storage medium 820, and any peripheral devices, the network interface 816 or other peripheral interfaces, such as input/output devices 818. In some implementations, the I/O interface 810 may perform any necessary protocol, timing or other data transformations to convert data signals from one component (e.g., non-transitory computer readable storage medium 820) into a format suitable for use by another component (e.g., processor(s) 802). In some implementations, the I/O interface 810 may include support for devices attached through various types of peripheral buses, such as a variant of the Peripheral Component Interconnect (PCI) bus standard or the Universal Serial Bus (USB) standard, for example. In some implementations, the function of the I/O interface 810 may be split into two or more separate components, such as a north bridge and a south bridge, for example. Also, in some implementations, some or all of the functionality of the I/O interface 810, such as an interface to the non-transitory computer readable storage medium 820, may be incorporated directly into the processor(s) 802.

The ESCs 804 communicate with the navigation system 807 and adjust the rotational speed of each lifting motor and/or the thrusting motor to stabilize the UAV and guide the UAV along a determined flight path. The navigation system 807 may include a GPS, indoor positioning system (IPS), IMU or other similar systems and/or sensors that can be used to navigate the UAV 100 to and/or from a location. The propeller configuration controller 812 communicates with actuator(s) or motor(s) (e.g., a servo motor) used to engage and/or disengage items.

The network interface 816 may be configured to allow data to be exchanged between the UAV control system 814, other devices attached to a network, such as other computer systems (e.g., remote computing resources), and/or with UAV control systems of other UAVs. For example, the network interface 816 may enable wireless communication between the UAV that includes the control system 814 and a UAV control system that is implemented on one or more remote computing resources. For wireless communication, an antenna of an UAV or other communication components may be utilized. As another example, the network interface 816 may enable wireless communication between numerous UAVs. In various implementations, the network interface 816 may support communication via wireless general data networks, such as a Wi-Fi network. For example, the network interface 816 may support communication via telecommunications networks, such as cellular communication networks, satellite networks, and the like.

Input/output devices 818 may, in some implementations, include one or more displays, imaging devices, thermal sensors, infrared sensors, time of flight sensors, accelerometers, pressure sensors, weather sensors, cameras, gimbals, landing gear, etc. Multiple input/output devices 818 may be present and controlled by the UAV control system 814. One or more of these sensors may be utilized to assist in landing as well as to avoid obstacles during flight.

As shown in FIG. 8, the memory may include program instructions 822, which may be configured to implement the example routines and/or sub-routines described herein. The data storage 824 may include various data stores for maintaining data items that may be provided for determining flight paths, landing, identifying locations for disengaging items, engaging/disengaging the thrusting motors, etc. In various implementations, the parameter values and other data illustrated herein as being included in one or more data stores may be combined with other information not described or may be partitioned differently into more, fewer, or different data structures. In some implementations, data stores may be physically located in one memory or may be distributed among two or more memories.

Those skilled in the art will appreciate that the UAV control system 814 is merely illustrative and is not intended to limit the scope of the present disclosure. In particular, the computing system and devices may include any combination of hardware or software that can perform the indicated functions. The UAV control system 814 may also be connected to other devices that are not illustrated, or instead may operate as a stand-alone system. In addition, the functionality provided by the illustrated components may, in some implementations, be combined in fewer components or distributed in additional components. Similarly, in some implementations, the functionality of some of the illustrated components may not be provided and/or other additional functionality may be available.

Those skilled in the art will also appreciate that, while various items are illustrated as being stored in memory or storage while being used, these items or portions of them may be transferred between memory and other storage devices for purposes of memory management and data integrity. Alternatively, in other implementations, some or all of the software components may execute in memory on another device and communicate with the illustrated UAV control system 814. Some or all of the system components or data structures may also be stored (e.g., as instructions or structured data) on a non-transitory, computer-accessible medium or a portable article to be read by an appropriate drive. In some implementations, instructions stored on a computer-accessible medium separate from the UAV control system 814 may be transmitted to the UAV control system 814 via transmission media or signals such as electrical, electromagnetic, or digital signals, conveyed via a communication medium such as a wireless link. Various implementations may further include receiving, sending, or storing instructions and/or data implemented in accordance with the foregoing description upon a computer-accessible medium. Accordingly, the techniques described herein may be practiced with other UAV control system configurations.

Although the subject matter has been described in language specific to structural features and/or methodological acts, it is to be understood that the subject matter defined in the appended claims is not necessarily limited to the specific features or acts described. Rather, the specific features and acts are disclosed as exemplary forms of implementing the claims.

What is claimed is:

1. An unmanned aerial vehicle (“UAV”) comprising:
a frame;
a lifting motor mounted to the frame;
a lifting propeller coupled to the lifting motor;
a thrusting motor mounted to the frame; and
a thrusting propeller coupled to the thrusting motor,
wherein the lifting propeller includes:
a hub coupled to the lifting motor;
a first rotatable member coupled to the hub;
a first blade coupled to and extending from the first rotatable member, wherein the first blade is rotatable by the first rotatable member; and
a second blade extending from the hub in an opposite direction from the first blade;
wherein the lifting propeller is in a operational configuration when the first blade is in a first orientation such that a leading edge of the first blade and a leading edge of the second blade are aligned in a direction of rotation of the lifting motor; and
wherein the lifting propeller is in a transit configuration when the first blade is in a second orientation such that the leading edge of the first blade and the leading edge of the second blade are aligned in a direction of a transit flight of the UAV.

2. The UAV of claim 1, wherein during the transit flight of the UAV:
the rotation of the lifting motor and lifting propeller is terminated;
the lifting propeller is in the transit configuration; and
the first blade and the second blade are aligned substantially perpendicular to the direction of the transit flight.

3. The UAV of claim 2, wherein:
an airfoil shape of the first blade generates a first positive lift in response to airflow passing the first blade during the transit flight; and
an airfoil shape of the second blade generates a second positive lift in response to airflow passing the second blade during the transit flight.

4. The UAV of claim 3, wherein an energy saved by the first positive lift is greater than an energy consumed from the first drag generated by the first blade during the transit flight.

5. The UAV of claim 1, wherein the first rotatable member includes a hinge that couples the first blade and the second blade such that the first blade, when adjusted, rotates about the hinge.

6. The UAV of claim 1, wherein the first rotatable member includes a rotatable drive that rotates the first blade about an axis such that the first blade and the second blade remain aligned during rotation of the first blade.

7. A propeller comprising:
a hub;
a first blade extending in a first direction from the hub; and
a second adjustable blade extending in a second direction from the hub, where the second adjustable blade is rotatable between a first position and a second position;
wherein:
a leading edge of the first blade and a leading edge of the second adjustable blade are aligned in a direction of rotation of the propeller when the propeller is in an operational configuration; and
the leading edge of the first blade and the leading edge of the second adjustable blade are aligned in a direction of transit flight of an aerial vehicle when the propeller is in a transit configuration.

8. The propeller of claim 7, further comprising:
a rotatable member coupled to the second adjustable blade and configured to rotate the second adjustable blade about an axis to position the second adjustable blade in either the first position or the second position.

9. The propeller of claim 8, wherein the rotatable member includes a hinge that causes the second adjustable blade to rotate about the hinge and extend in the first direction when the propeller is in the transit configuration.

10. The propeller of claim 8, wherein the rotatable member causes the second adjustable blade to rotate while the second adjustable blade remains extended in the second direction.

11. The propeller of claim 8, wherein at least a portion of the second rotatable blade overlaps at least a portion of the first blade when the propeller is in the transit configuration.

12. The propeller of claim 7, wherein the rotatable member includes a vertical offset that causes the second adjustable blade to move in a vertical direction as it rotates about the axis.

13. The propeller of claim 12, wherein:
the third blade is aligned approximately parallel to the direction of a transit flight when the propeller is in the transit configuration;
the first blade is approximately perpendicular to the direction of the transit flight when the propeller is in the transit configuration; and
the second adjustable blade is approximately perpendicular to the direction of the transit flight when the propeller is in the transit configuration.

14. The propeller of claim 7, wherein the first blade and the second adjustable blade:
generate a first positive lift force in response to a rotation of the propeller when the propeller is in the operational configuration; and
generate a second positive lift force in response to airflow passing over the first blade and the second rotational blade when the propeller is in a transit configuration and the aerial vehicle is in a transit flight.

15. The propeller of claim 14, wherein a difference between a net energy saved when the propeller is in a transit configuration and aligned in the direction of transit flight is greater than a net energy saved if the first blade and the second blade are aligned parallel with a direction of the transit flight.

16. A method to operate an aerial vehicle, the method comprising:
rotating with a lifting motor a lifting propeller to generate a first positive lifting force to cause the aerial vehicle to perform a vertical flight;
rotating with a thrusting motor a thrusting propeller to generate a thrusting force to cause the aerial vehicle to perform a transit flight;
terminating a rotation of the first lifting propeller during the transit flight;
rotating a first blade of the lifting propeller such that a leading edge of the first blade and a leading edge of a second blade of the lifting propeller are both aligned toward a direction of the transit flight;
affixing the lifting propeller such that:
a second positive lifting force is generated by the first blade in response to airflow passing the first blade during the transit flight; and
a third positive lifting force is generated by the second blade in response to airflow passing the second blade during the transit flight.

17. The method of claim 16, wherein an energy saved in response to the second positive lifting force is greater than an energy consumed in response to a drag from the first blade during the transit flight.

18. The method of claim 16, further comprising:
altering an airfoil shape of the first blade to at least increase the second positive lift, or decrease a drag from the first blade during the transit flight.

19. The method of claim 18, wherein the airfoil shape is at least one of a camber, a blade thickness, a chord, a pitch, an angle of attack distribution, a camber distribution, a rake angle, or axial offset of the blade into different planes.

20. The method of claim 18, wherein affixing the lifting propeller further includes affixing the lifting propeller such that a third blade of the lifting propeller is approximately parallel to a direction of the transit flight.
